(19) United States
(12) Patent Application Publication
(10) Pub. No.: US 2015/0157967 A1
(43) Pub. Date: Jun. 11, 2015

(54) Water Filter Cartridge and Assembly

(71) Applicant: General Electric Company, Schenectady, NY (US)

(72) Inventors: Andrew Reinhard Krause, La Grange, KY (US); Gregory Sergeevich Chernov, Louisville, KY (US)

(73) Assignee: General Electric Company, Schenectady, NY (US)

(21) Appl. No.: 14/098,771

(22) Filed: Dec. 6, 2013

(51) Int. Cl. B01D 35/153; B01D 35/30

(52) U.S. Cl. CPC B01D 35/153; B01D 35/306

(57) ABSTRACT

Water filter cartridges, water filter assemblies, and refrigerator appliances are provided. A water filter cartridge includes a cap, the cap defining a generally central aperture, and a canister connected to the cap. The water filter cartridge further includes a filter media disposed within the canister and cap, and a flange connected to the filter media. The flange includes a neck and a collar, the neck extending from the collar generally along an axial direction, the collar extending from the neck generally along a radial direction. The flange further includes a ramp extending generally along the axial direction from the collar, at least a portion of the ramp extending through the aperture of the cap.

### FIELD OF THE INVENTION

The present subject matter relates generally to water filter cartridges and assemblies, such as those utilized in refrigerator appliances.

### BACKGROUND OF THE INVENTION

Water filter assemblies are utilized in a variety of environments. For example, Certain refrigerator appliances include water filter assemblies for filtering water. Water filter assemblies can filter water entering the refrigerator appliances in order to provide filtered water to various refrigerator appliance components, such as an ice maker and/or a water dispenser. Such filtering can improve a taste and/or an appearance of water within the refrigerator appliances.

Certain water filter assemblies include a manifold and a filter cartridge. The manifold is mounted to a cabinet of the refrigerator appliance and directs unfiltered water into the filter cartridge and filtered water out of the filter cartridge. The filter cartridge includes a filter media, such as an activated carbon block, a pleated polymer sheet, a spun cord material, or a melt blown material. The filter media is positioned within the filter cartridge and filters water passing therethrough.

Many presently known water filter assemblies include fail-safe features designed to actuate in the event of, for example, excess pressure in the water filter cartridge. Typically, the cartridge is designed to fail at the connection between the canister and cap thereof. The canister is thus ejected from the assembly, while the filter media and cap remain attached to the manifold. However, such design can lead to water leak issues. For example, the cap typically includes one or more ramps which engage a check valve in the manifold, allowing water to flow through the manifold into the cartridge. Since the cap is not ejected, the check valve remains engaged by the ramps, and water can continue to flow. Since the cartridge has been ejected, this flow of water can caused damage to the environment surrounding the water filter assembly and can require significant cleanup. In some cases, significant flooding and extensive property damage can occur.

Accordingly, improved water filter cartridges and assemblies, such as those utilized in refrigerator appliances, are desired in the art. In particular, water filter cartridges and assemblies which include fail-safe features that do not risk water leakage issues would be advantageous.

### BRIEF DESCRIPTION OF THE INVENTION

In one embodiment, a water filter cartridge is provided. The water filter cartridge includes a cap, the cap defining a generally central aperture, and a canister connected to the cap. The water filter cartridge further includes a filter media disposed within the canister and cap, and a flange connected to the filter media. The flange includes a neck and a collar, the neck extending from the collar generally along an axial direction, the collar extending from the neck generally along a radial direction. The flange further includes a ramp extending generally along the axial direction from the collar, at least a portion of the ramp extending through the aperture of the cap.

In another embodiment, a water filter assembly is provided. The water filter assembly includes a manifold that defines an inlet for receiving unfiltered water and an outlet for directing filtered water out of the water filter assembly, the manifold comprising a check valve. The water filter assembly further includes a filter cartridge mounted to the manifold. The filter cartridge includes a cap, the cap defining a generally central aperture, and a canister connected to the cap. The filter cartridge further includes a filter media disposed within the canister and cap, and a flange connected to the filter media. The flange includes a neck and a collar, the neck extending from the collar generally along an axial direction, the collar extending from the neck generally along a radial direction. The flange further includes a ramp extending generally along the axial direction from the collar, at least a portion of the ramp extending through the aperture of the cap. The ramp is configured to contact the check valve.

In another embodiment, a refrigerator appliance is provided. The refrigerator appliance includes a cabinet that defines a chilled chamber for receipt of food articles for storage, and a water filter assembly mounted to the cabinet. The water filter assembly includes a manifold that defines an inlet for receiving unfiltered water and an outlet for directing filtered water out of the water filter assembly, the manifold comprising a check valve. The water filter assembly further includes a filter cartridge mounted to the manifold. The filter cartridge includes a cap, the cap defining a generally central aperture, and a canister connected to the cap. The filter cartridge further includes a filter media disposed within the canister and cap, and a flange connected to the filter media. The flange includes a neck and a collar, the neck extending from the collar generally along an axial direction, the collar extending from the neck generally along a radial direction. The flange further includes a ramp extending generally along the axial direction from the collar, at least a portion of the ramp extending through the aperture of the cap. The ramp is configured to contact the check valve.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance with refrigerator doors of the refrigerator appliance shown in a closed position in accordance with one embodiment of the present disclosure.

FIG. 2 provides a front, elevation view of the exemplary refrigerator appliance of FIG. 1 with refrigerator doors of the refrigerator appliance shown in an open position.

FIG. 3 provides an assembled front view of a water filter cartridge in accordance with one embodiment of the present disclosure.

FIG. 4 provides an exploded front view of a water filter cartridge in accordance with one embodiment of the present disclosure.

FIG. 5 provides a perspective view of a portion of a manifold in accordance with one embodiment of the present disclosure.

FIG. 6 provides a top perspective view of a cap of a water filter cartridge in accordance with one embodiment of the present disclosure.

FIG. 7 provides a perspective view of a flange of a water filter cartridge in accordance with one embodiment of the present disclosure.

FIG. 8 provides a top perspective view of an assembled cap and flange of a water filter cartridge in accordance with one embodiment of the present disclosure.

FIG. 9 provides a perspective view of a flange of a water filter cartridge in accordance with another embodiment of the present disclosure.

FIG. 10 provides a top perspective view of an assembled cap and flange of a water filter cartridge in accordance with another embodiment of the present disclosure.

FIG. 11 provides a cross-sectional view of an assembled water filter assembly in accordance with one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

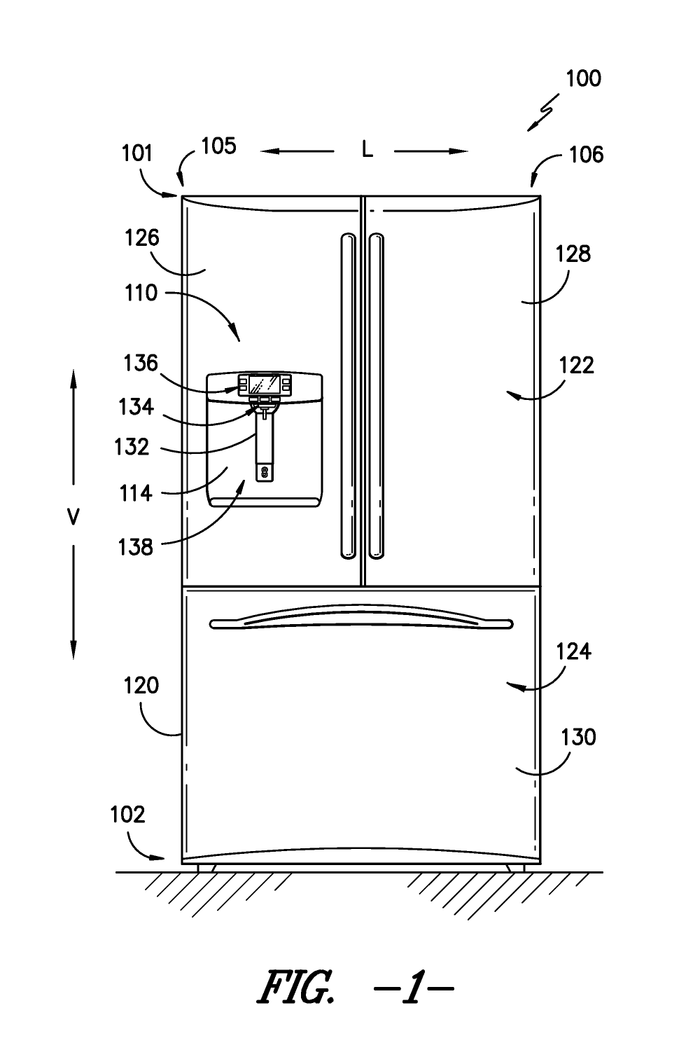

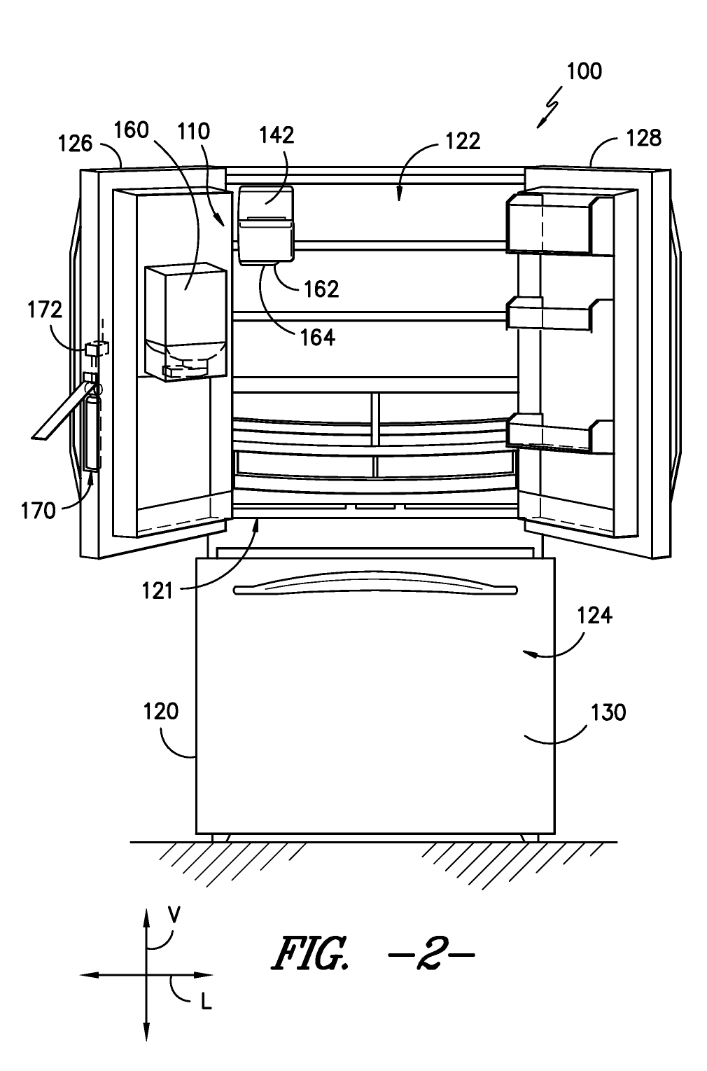

FIG. 1 provides a front, elevation view of a refrigerator appliance 100 according to an exemplary embodiment of the present subject matter. FIG. 2 provides a front, elevation view of refrigerator appliance 100 with refrigerator doors 126 and 128 of refrigerator appliance 100 shown in an open position to reveal a fresh food chamber 122 of refrigerator appliance 100. Refrigerator appliance 100 defines a vertical direction V, a transverse direction T (FIG. 3), and a lateral direction L. The vertical direction V, transverse direction T, and lateral direction L are mutually perpendicular and form an orthogonal direction system. Refrigerator appliance 100 extends between an upper portion 101 and a lower portion 102 along the vertical direction V. Refrigerator appliance 100 also extends between a first side portion 105 and a second side portion 106 along the lateral direction L.

Refrigerator appliance 100 includes a cabinet or housing 120 that defines chilled chambers for receipt of food items for storage. In particular, refrigerator appliance 100 defines fresh food chamber 122 at upper portion 101 of refrigerator appliance 100 and a freezer chamber 124 arranged below fresh food chamber 122 on the vertical direction V, e.g., at lower portion 102 of refrigerator appliance 100. As such, refrigerator appliance 100 is generally referred to as a bottom mount refrigerator appliance. However, using the teachings disclosed herein, one of skill in the art will understand that the present subject matter may be used with other types of refrigerator appliances (e.g., side-by-side style or top mount style) or a freezer appliance as well. Consequently, the description set forth herein is for illustrative purposes only and is not intended to limit the present subject matter in any aspect.

Refrigerator doors 126 and 128 are rotatably hinged to an edge of housing 120 for accessing fresh food chamber 122. In particular, housing 120 defines an opening 121. Opening 121 of housing 120 permits access to fresh food chamber 122 of housing 120. Refrigerator doors 126 and 128 are positioned at opening 121 of housing 120 and permit selective access to fresh food chamber 122 of housing 120 through opening 121 of housing 120, e.g., by rotating between the open and closed positions. A freezer door 130 is arranged below refrigerator doors 126 and 128 for accessing freezer chamber 124. Freezer door 130 is coupled to a freezer drawer (not shown) slidably mounted within freezer chamber 124.

Refrigerator appliance 100 also includes a dispensing assembly 110 for dispensing water and/or ice. Dispensing assembly 110 includes a dispenser 114 positioned on or mounted to an exterior portion of refrigerator appliance 100, e.g., on refrigerator door 126. Dispenser 114 includes a discharging outlet 134 for accessing ice and water. A sensor 132, such as an ultrasonic sensor, is mounted below discharging outlet 134 for operating dispenser 114. In alternative exemplary embodiments, any suitable actuator may be used to operate dispenser 114. For example, dispenser 114 can include a paddle or button rather than sensor 132. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and sensor 132 are an external part of dispenser 114 and are mounted in a dispenser recess 138 defined in an outside surface of refrigerator door 126. Dispenser recess 138 is positioned at a predetermined elevation convenient for a user to access ice or water and enabling the user to access ice without the need to bend-over and without the need to access freezer chamber 124. In the exemplary embodiment, dispenser recess 138 is positioned at a level that approximates the chest level of a user.

Turning now to FIG. 2, certain components of dispensing assembly 110 are illustrated. Dispensing assembly 110 includes an insulated housing 142 mounted within fresh food chamber 122. Due to the insulation which encloses insulated housing 142, the temperature within insulated housing 142 can be maintained at levels different from the ambient temperature in the surrounding fresh food chamber 122.

Insulated housing 142 is constructed and arranged to operate at a temperature that facilitates producing and storing ice. More particularly, insulated housing 142 contains an ice maker (not shown) for creating ice and feeding the same to a container 160 that is mounted on refrigerator door 126. As illustrated in FIG. 2, container 160 is placed at a vertical position on refrigerator door 126 that will allow for the receipt of ice from a discharge opening 162 located along a bottom edge 164 of insulated housing 142. As refrigerator door 126 is closed or opened, container 160 is moved in and out of position under insulated housing 142.

Refrigerator appliance 100 also includes a water filter assembly 170. Water filter assembly 170 can filter water from a water supply (not shown), such as a municipal water source or a well. Water filter assembly 170 can remove contaminants and other undesirable substances from water passing therethrough. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water filter assembly 170 is mounted to housing 120. In particular, water filter assembly 170 is mounted to refrigerator door 126 in the exemplary embodiment shown in FIG. 2. However, it should be understood that water filter assembly 170 can be positioned at any other suitable location within refrigerator appliance 100 in alternative exemplary embodiments. For example, water filter assembly 170 may be mounted to refrigerator door 128, to housing 120 within fresh food chamber 122, or to housing 120 below freezer chamber 124 in alternative exemplary embodiments. Thus, the position of water filter assembly 170 shown in FIG. 2 is not intended to limit the present subject matter in any aspect and is provided by way of example only.

It should further be understood that the present disclosure is not limited to water filter assemblies 170 in refrigerator appliances 100, and rather that any suitable water filter assemblies are within the scope and spirit of the present disclosure.

Refrigerator appliance 100 also includes a valve 172 as schematically shown in FIG. 2. Valve 172 is configured for regulating a flow of water to water filter assembly 170. In particular, valve 172 can selectively shift between a closed position and an open position. Valve 172 permits the flow of water to water filter assembly 170 in the open position. Thus, with valve 172 in the open position, water for filtering is supplied to water filter assembly 170. Conversely, valve 172 obstructs or blocks the flow of water to water filter assembly 170 in the closed position. Thus, with valve 172 in the closed position, water for filtering is not supplied to water filter assembly 170 or is supplied to water filter assembly 170 in an insubstantial volume. In such a manner, valve 172 can regulate the flow of water to water filter assembly 170 by shifting between the open and closed positions.

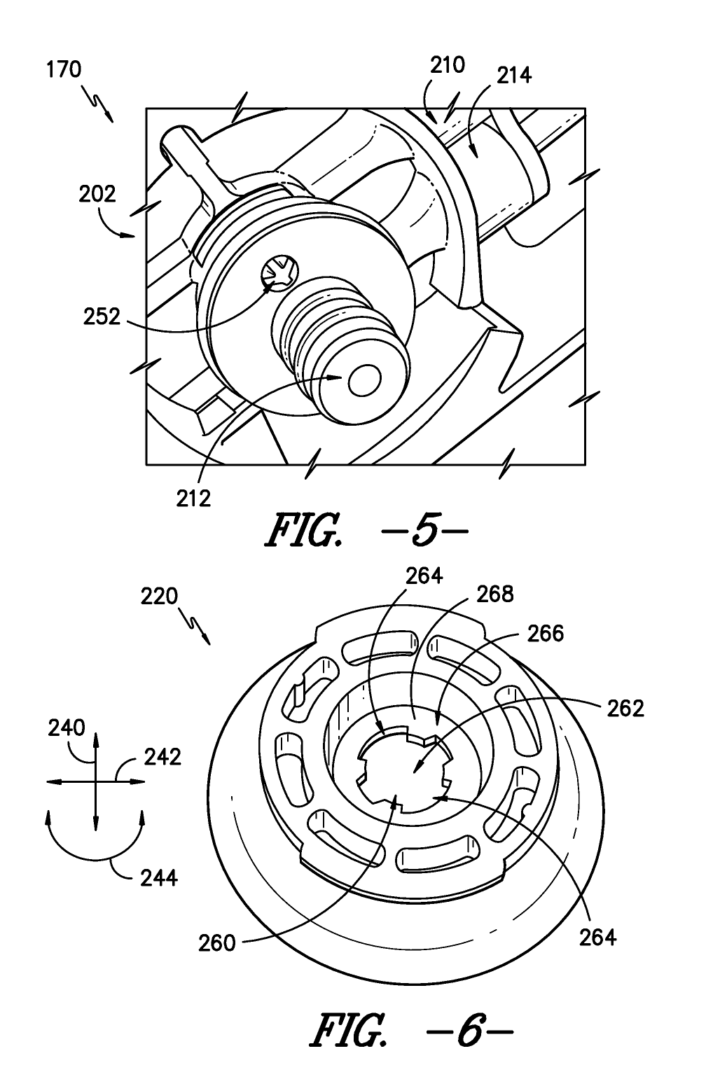

Referring now to FIGS. 3 through 5, various embodiments of components of a water filter assembly 170 are illustrated. A water filter assembly 170 may include, for example, a manifold 202 and a water filter cartridge 204. Manifold 202 may be configured for receiving unfiltered water and directing filtered water out of water filter assembly 170. In exemplary embodiments, and referring to FIG. 5, manifold 202 includes an inlet conduit 210 that defines an inlet 212. Inlet 212 receives unfiltered water, e.g., from a water source (not shown) such as a municipal water supply or a well. Manifold 202 also includes an outlet conduit 214 that defines an outlet (not shown). The outlet directs filtered water out of water filter assembly 170. Thus, manifold 202 receives unfiltered water at inlet 212. Such unfiltered water passes through water filter assembly 170 and exits manifold 202 at the outlet as filtered water.

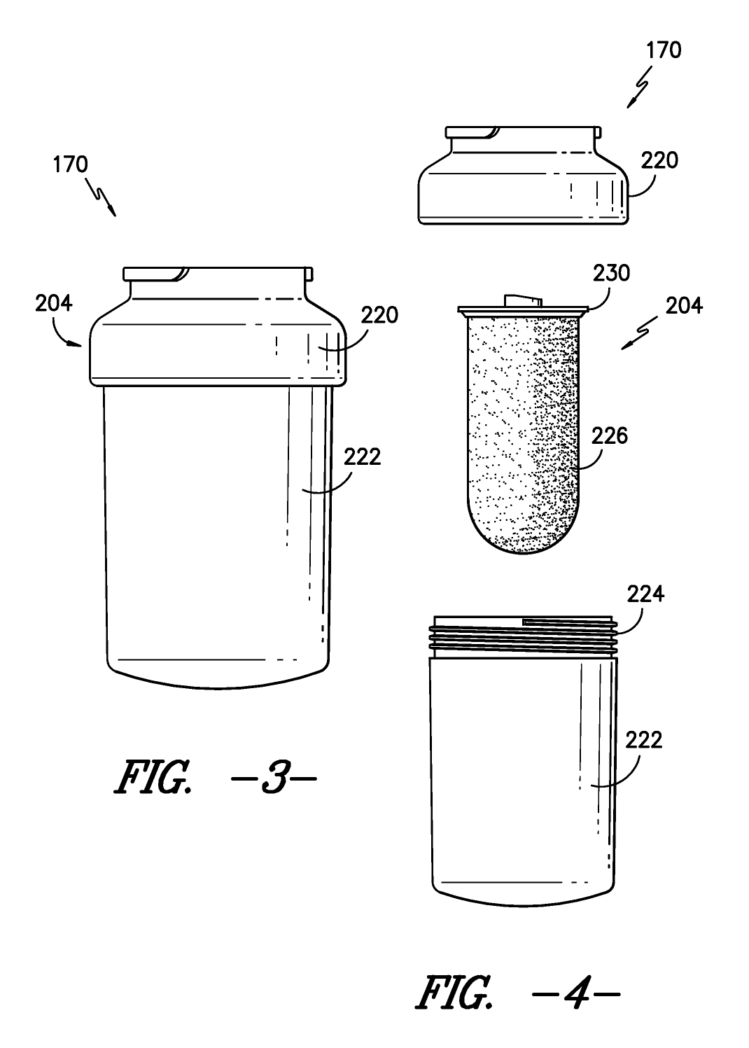

Referring again to FIGS. 3 and 4, water filter cartridge 204 may interact with manifold 202 such that unfiltered water from inlet 212 is flowed into the cartridge 204, and filtered water is flowed out of cartridge 204 through the outlet. Cartridge 204 may include a cap 220 and a canister 222. Canister 222 may, for example, be removably connected to the cap 220 when in an assembled state. For example, outer threads 224 defined on canister 222 may mate with inner threads 225 (see FIG. 11) of the cap 220 to removably connect the canister 222 and cap 220. Alternatively, canister 222 may be welded or otherwise fixidly connected to the cap 220 when in an assembled state.

Water filter cartridge 204 may further include a filter media 226, which as shown may be disposed within the canister 222 and cap 220 when assembled. The filter media 226 may include any suitable mechanism for filtering water within water filter assembly 170. For example, filter media 226 may include an activated carbon block, a reverse osmosis membrane, a pleated polymer or cellulose sheet, or a melt blown or spun cord media. As used herein, the term “unfiltered” describes water that is not filtered relative to filter media 226. However, as will be understood by those skilled in the art, water filter assembly 170 may include additional filters that filter water entering chamber 231. Thus, “unfiltered” may be filtered relative to other filters but not filter media 226. Unfiltered water may flow through cap 220 into water filter cartridge 204 from manifold 202, and filtered water may flow through cap 220 from water filter cartridge 204 into manifold 202.

Water filter cartridge 204 may additionally include a flange 230. Flange 230 may be connected to the filter media 226, such as to an upper end thereof. Flange 230 generally connects and locates the filter media 226 within the cap 220 and canister 222. Further, as discussed herein, flange 230 may engage the manifold to facilitate the flow of unfiltered water to the cartridge 204.

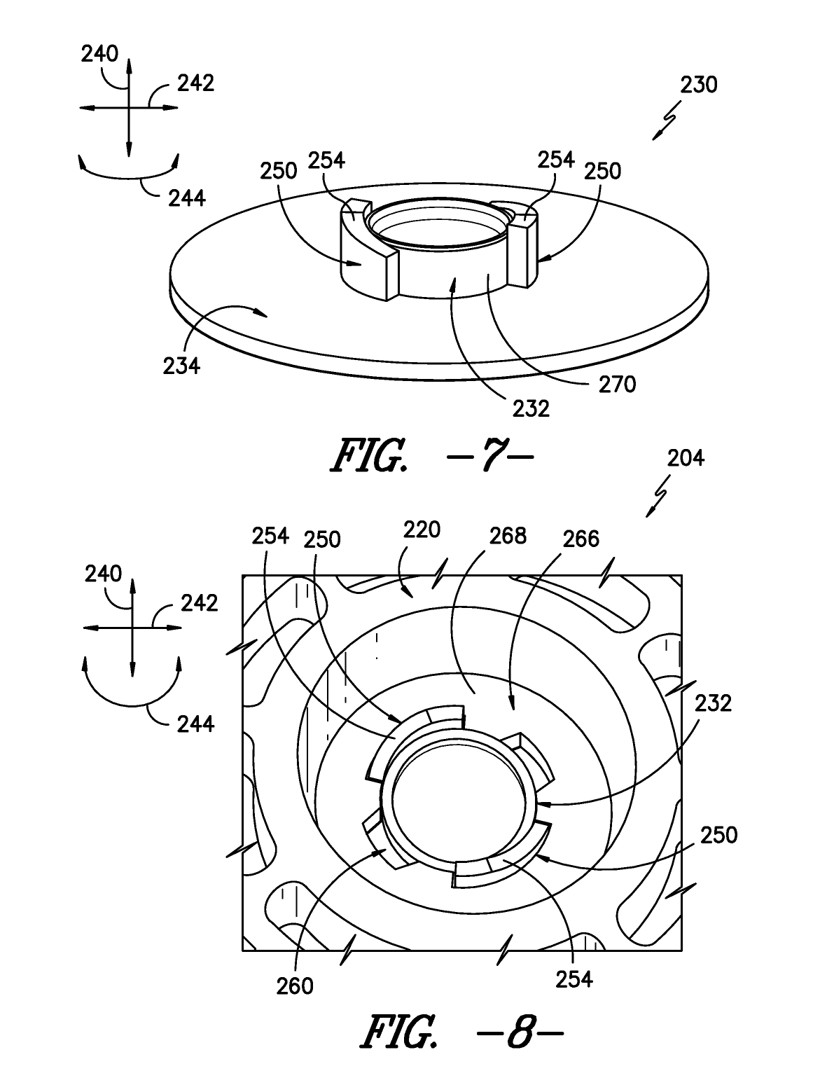

Referring now to FIGS. 7 and 9, flange 230 may include a neck 232 and a collar 234. Neck 232 may extend from collar 234 generally along an axial direction 240 of the flange 230. Collar 234 may extend from neck 232 generally along a radial direction 242 of the flange 230. A circumferential direction 244 of the flange 230 may additionally be defined, as illustrated.

As discussed, improved water filter assemblies 170 and cartridges 204, particularly which include fail-safe features that do not risk water leakage issues, would be advantageous. Accordingly, and referring to FIGS. 5 and 7 through 11, a flange 230 according to the present disclosure may further include one or more ramps 250. Each ramp 250 is configured to interact with a check valve 252 of the manifold 202. For example, and as illustrated in FIG. 11, a ramp 250 may extend through cap 220 and an upper surface 254 thereof may contact check valve 252, depressing the check valve 252. Such depression may allow unfiltered water to flow from inlet 212 into the cartridge 204.

A ramp 250, as illustrated, may extend from the collar 242 generally along the axial direction 240. Further, as illustrated, in exemplary embodiments, ramp 250 may extend about at least a portion of the neck 232 generally along the circumferential direction 244. Thus, ramp 250 may for example be generally arcuate. As further illustrated, in exemplary embodiments, the ramp 250 may taper, such that the axial height thereof changes along the circumferential length. Ramp 250, such as at least a portion thereof, may thus taper towards the collar 242 generally along the circumferential direction. Still further, in exemplary embodiments, at least a portion of the ramp 250 may extend beyond the neck 232 generally along the axial direction 240. Thus, at least a portion of the ramp 250 may have a height from the collar 242 that is greater than the height of the neck 232.

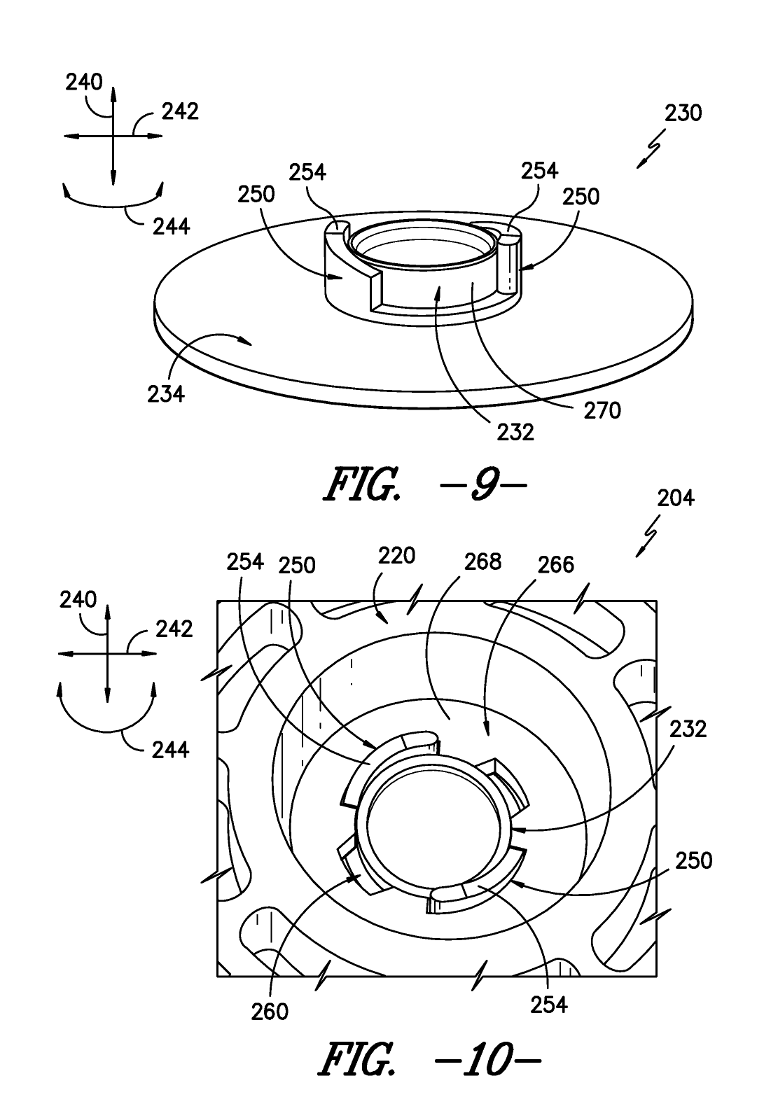

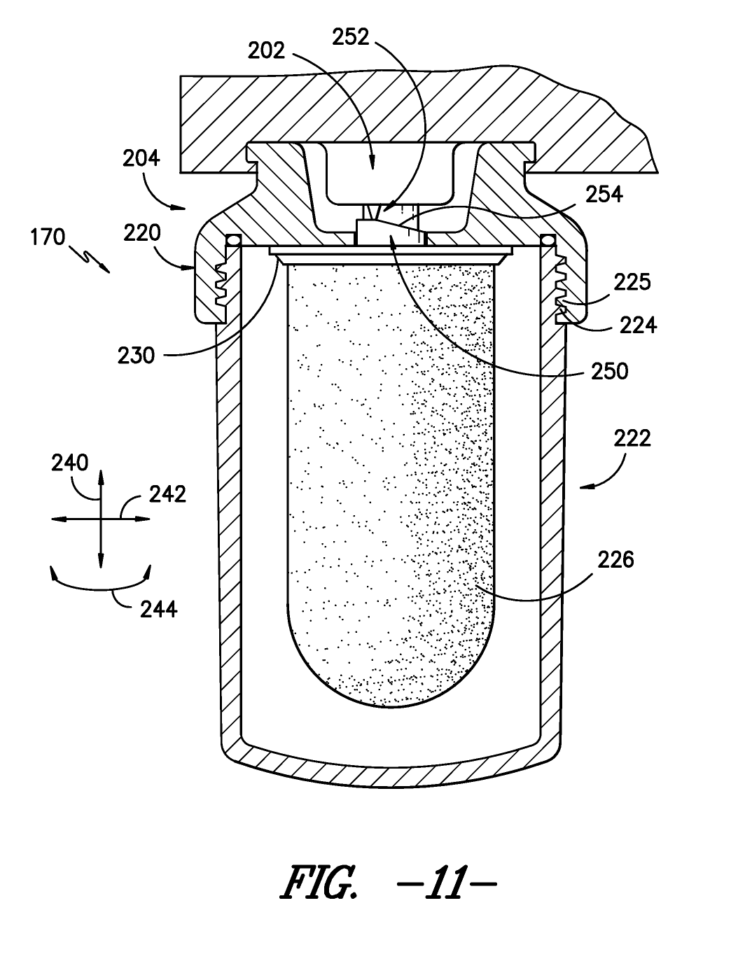

In exemplary embodiments, as illustrated in FIGS. 7 and 8, ramps 250 may be integral with the flange 230. Thus, for example, the collar 234, neck 232, and ramps 250 may be formed as a unitary component from a single piece of material. In alternative exemplary embodiments, as illustrated in FIGS. 9 and 10, ramps 250 may be connected to the flange 230, such as to the collar 234 and/or neck 232. In these embodiments, ramps 250 may be formed separately from the collar 234 and neck 232. The ramps 250 may be connected to the collar 234 and/or neck 232 using a suitable mechanical fastener, an adhesive, or any other suitable connection device.

As discussed, ramps 250 may contact check valve 252. Thus, as illustrated in FIGS. 6, 8 and 10, cap 220 may define a generally central aperture 260 through which at least a portion of ramps 250 may extend (generally along the axial direction 240). Central aperture 260 may include, for example, a central portion 262 and ramp cutouts 264 extending generally along the radial direction 242 from central portion 262. Ramps 250 may extend through the ramp cutouts 264 such that upper surface 254 thereof can contact check valve 252. Further, ramp cutouts 264 may advantageously control movement, such as rotation, of the ramps 250, thus controlling the interaction and contact between a ramp 250 and check valve 252.

Referring briefly to FIG. 11, when a ramp 250 and check valve 252 are engaged such that the check valve 252 is engaged, the flange 230, as well as the filter media 226 and cap 220, may be removably connected to the manifold 202. As discussed, canister 222 is removably connectable to the cap 220. Such connections form an assembled water filter assembly 170. To engage a ramp 250 and check valve 252, flange 230 may be rotated, generally about an axis defined along the axial direction 240, such that the ramp 250 gradually engages the check valve 252.

Referring again to FIGS. 6 through 10, cap 220 may further include a generally central wall 266 that surrounds and defines the generally central aperture 260. Wall 266 may extend generally along the radial direction from the generally central aperture 260, thus defining aperture 260. In exemplary embodiments as illustrated, central wall 266 may comprise a generally smooth outer surface 268. Thus, no projections or surface features may extend from the outer surface 268. In particular, no ramps or other features for engaging the manifold 202 may extend from the outer surface 268. Advantageously, the smooth outer surface 268 allows the flange 230, rather than the cap 220, to engage the manifold 202.

Neck 232 may additionally include an outer surface 270 that is generally smooth, with no projections or surface features extending therefrom. In particular, no tabs for locking the neck 232 in connection with the manifold 202 may extend from the outer surface 270. Advantageously, the smooth outer surface 270 allows the flange 230 to be removably connected to the manifold 202. For example, cartridge 204 may include fail-safe features such that the cartridge 204 is designed to fail due to, for example, excess internal pressures. The cartridge 204 may for example be designed to fail at the connection between the canister 222 and cap 220. Further, because the flange 230 has a smooth outer surface 270, rather than any locking tabs, the flange 230 may be free to separate from the manifold when a failure event occurs. Since the flange 230 includes ramps 250 for engaging the check valve 252, the check valve 252 may be disengaged when a failure event occurs, thus advantageously preventing leakage and flooding.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filter cartridge, comprising:
a cap, the cap defining a generally central aperture;
a canister connected to the cap;
a filter media disposed within the canister and cap;
a flange connected to the filter media, the flange comprising a neck and a collar, the neck extending from the collar generally along an axial direction, the collar extending from the neck generally along a radial direction, the flange further comprising a ramp extending generally along the axial direction from the collar, at least a portion of the ramp extending through the aperture of the cap.

2. The water filter cartridge of claim 1, wherein the ramp further extends about at least a portion of the neck generally along a circumferential direction.

3. The water filter cartridge of claim 2, wherein the ramp tapers towards the collar generally along the circumferential direction.

4. The water filter cartridge of claim 1, wherein at least a portion of the ramp extends beyond the neck generally along the axial direction.

5. The water filter cartridge of claim 1, wherein the neck comprises a generally smooth outer surface.

6. The water filter cartridge of claim 1, wherein the cap further comprises a generally central wall surrounding and defining the generally central aperture, the central wall comprising a generally smooth outer surface.

7. The water filter cartridge of claim 1, wherein the ramp is integral with the flange.

8. The water filter cartridge of claim 1, wherein the ramp is connected to the flange.

9. The water filter cartridge of claim 1, wherein the ramp is a plurality of ramps.

10. A water filter assembly, comprising:
a manifold that defines an inlet for receiving unfiltered water and an outlet for directing filtered water out of the water filter assembly, the manifold comprising a check valve;
a filter cartridge mounted to the manifold, filter cartridge comprising:
a cap, the cap defining a generally central aperture;
a canister connected to the cap;
a filter media disposed within the canister and cap;
a flange connected to the filter media, the flange comprising a neck and a collar, the neck extending from the collar generally along an axial direction, the collar extending from the neck generally along a radial direction, the flange further comprising a ramp extending generally along the axial direction from the collar, at least a portion of the ramp extending through the aperture of the cap, the ramp configured to contact the check valve.

11. The water filter assembly of claim 10, wherein the ramp further extends about at least a portion of the neck generally along a circumferential direction.

12. The water filter assembly of claim 11, wherein the ramp tapers towards the collar generally along the circumferential direction.

13. The water filter assembly of claim 10, wherein at least a portion of the ramp extends beyond the neck generally along the axial direction.

14. The water filter assembly of claim 10, wherein the neck comprises a generally smooth outer surface.

15. The water filter assembly of claim 10, wherein the cap further comprises a generally central wall surrounding and defining the generally central aperture, the central wall comprising a generally smooth outer surface.

16. The water filter assembly of claim 10, wherein the generally central aperture comprises a central portion and a ramp cutout, and wherein the ramp extends through the ramp cutout.

17. The water filter assembly of claim 10, wherein the ramp is integral with the flange.

18. The water filter assembly of claim 10, wherein the ramp is connected to the flange.

19. The water filter assembly of claim 10, wherein the ramp is a plurality of ramps.

20. A refrigerator appliance, comprising:
a cabinet that defines a chilled chamber for receipt of food articles for storage; and
a water filter assembly mounted to the cabinet, the water filter assembly comprising:
a manifold that defines an inlet for receiving unfiltered water and an outlet for directing filtered water out of the water filter assembly, the manifold comprising a check valve;
a filter cartridge mounted to the manifold, filter cartridge comprising:
a cap, the cap defining a generally central aperture;
a canister connected to the cap;
a filter media disposed within the canister and cap;
a flange connected to the filter media, the flange comprising a neck and a collar, the neck extending from the collar generally along an axial direction, the collar extending from the neck generally along a radial direction, the flange further comprising a ramp extending generally along the axial direction from the collar, at least a portion of the ramp extending through the aperture of the cap, the ramp configured to contact the check valve.
